(19) United States
(12) Patent Application Publication
(10) Pub. No.: US 2003/0123165 A1
(43) Pub. Date: Jul. 3, 2003

(54) Side mirror

(76) Inventor: Wei-Li Lin, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/033,936

(22) Filed: Jan. 3, 2002

(51) Int. Cl. G02B 5/10

(52) U.S. Cl. 359/868

(57) ABSTRACT

A side mirror has an inner edge connected to a car and an outer edge. The front surface of the side mirror is defined by arcs of many circles becoming smaller and smaller in sizes such that the outer edge thereof has a greater curvature than the inner edge; the arcs are orientated in such a manner that every adjacent two thereof have a common tangent line at the joint. The front surface is further defined by arcs of many circles of different sizes such that a lower portion thereof has a greater curvature that an upper portion, the arcs are also orientated such that every adjacent two thereof have common tangent line at the joint. Thus, the part of the side mirror close to the lower edge and the outer edge has increased curvature for enlarging the range of visibility.

### BACKGROUND OF THE INVENTION

The present invention relates to a side mirror, and more particularly, a side mirror, which can reflect images of objects to the automobile driver without distortion that can't be easily seen with conventional side mirrors.

Referring to FIG. 1, a first conventional side mirror is made of glass having a surface curved according to the surface of sphere, of which the radius is 1800 millimeters. The visible angel, which is measured between the defining line and the normal to the face of the driver, is about only 5 to 7 degrees, i.e. when other cars move beyond the imaginary defining line as shown in FIG. 1, which forms an angle of 7 degrees together with a line parallel to the side of the car, the driver can't see the images of the other cars from the mirror, therefore the driver, being not aware of the other cars that are actually moving along a short distance behind at two sides of his car, is likely to change lanes and cause accident.

To overcome the drawback of the above mentioned side mirror, a convex mirror is attached to the outer lower part of the side mirror such that the range of visibility can be enlarged. However, because the curvature of the convex mirror is much greater than that of the rest of the side mirror, the image of objects will be greatly distorted on the joint between the convex mirror and the side mirror, making the driver unable to know the real distance between has car and the nearby cars from the convex mirror or the side mirror. Consequently, the driver might become confused by the greatly distorted images reflected by the side mirror.

Referring to FIG. 2, a second conventional side mirror is provided with a flat surface, or a surface curved according to a sphere with a radius of 1800 mm or so, and a concave portions on the edge of the back, such as the L-shaped portion shown in FIG. 2, hoping that the range of visibility can be enlarged. However, it is found that the side mirror with the concave edge on the back is not improved in respect of the range of visibility. And, the concave edge on the back will cause distortion of the images, making the driver further prone to make mistakes.

Referring to FIG. 3, a third conventional side mirror includes a flat front surface 80, and a rear surface 90 provided for refracting the light. The front surface 80 is completely flat for allowing the light to travel through. The rear surface 90 includes a main portion 901 defined by Y₀, Yₙ, and Xₙ; the main portion 901 tapers off towards the right edge; in other words, the width of the side mirror at the part marked with Xₙ is larger than the part marked with Xₒ.

A curved surface 902 is formed adjacent to the main portion 901 on the rear surface 90 such that the width at the outer edge, Zₙ, is larger than the part with Xₙ. Furthermore, a curved surface 903 is formed adjacent to the lower edge of the main portion 901. Thus, the angle of visibility can be enlarged, and the dazzling reflection of light from lamps of other cars can be reduced. However, because the front surface of the main portion 901 is flat, and the main portion 901 forms most area of the side mirror, i.e. the curved surfaces 902 and 903 are relatively small as compared to the main portion 901, the images are likely to be distorted.

Referring to FIG. 4, a fourth conventional side mirror consists of a main part, and a complementary part on the right and the lower edges of the main part; the main part is curved according to the surface of a sphere with a radius of 1000 to 5000 mm; the complementary part is made according to the surface of a sphere with a radius of 150 to 1000 mm. Thus, the range of visibility is greatly enlarged by means of the complementary part. However, the images of objects on the joint between the main part and the complementary part will be greatly distorted because the curvature of the complementary part is much larger than that of the main part. Consequently, the driver is likely to be confused and cause accidents when driving.

### SUMMARY OF THE INVENTION

Therefore, it is a main object of the present invention to provide a side mirror which can help the range of visibility increase without causing distortion of the images of objects.

The side mirror of the present invention includes a front surface, a rear side, and an inner edge connected to the car.

The front surface is defined by arcs of many circles becoming smaller and smaller in radius such that an outer end portion thereof has a greater curvature than an inner end position; the arcs are orientated in such a manner that every adjacent two thereof have a common tangent line at the joint. The front surface are further defined by arcs of many circles in the same way such that the lower portion thereof has a greater curvature than the upper portion, the arcs are also orientated in such a manner that every adjacent two thereof have a common tangent line at the joint.

Therefore, the portions of the side mirror close to the outer edge and the lower edge thereof are so curved as to increase the range of visibility for driver. And, because of the way in which the defining arcs are formed and orientated, the side mirror is curved gradually and not like the surface of a sphere so as not to cause distortion of the images.

### BRIEF DESCRIPTION OF THE DRAWINGS

The present invention will be better understood by reference to the accompanying drawings, wherein:

FIG. 1 is view illustrating the use of the first conventional side mirror as described in the Background.

FIG. 2 is a view of the second conventional side mirror as described in the Background.

FIG. 3 is a view of the third conventional side mirror as described in the Background.

FIG. 4 is a view of the fourth conventional side mirror as described in the Background.

FIG. 5 is a perspective view of the side mirror of the present invention.

FIG. 6 is a cross-sectional view of the side mirror of the present invention.

FIG. 7 is another cross-sectional view of the side mirror of the present invention.

FIG. 8 is a view illustrating the use of the side mirror of the present invention.

FIG. 9 is another view illustrating the use of the side mirror of the present invention.

FIG. 10 is a view of the arcs of the circles used for defining the side mirror of FIG. 5 from the right edge to the left edge.

FIG. 11 is a view of the arcs of the circles used for defining the side mirror of FIG. 5 from the upper part to the lower part.

FIG. 12 is a first view illustrating the formation and orientation of the arcs taken from the circles.

FIG. 13 is a second view illustrating the formation and orientation of the arcs taken from the circles.

FIG. 14 is a third view illustrating the formation and orientation of the arcs of the circles.

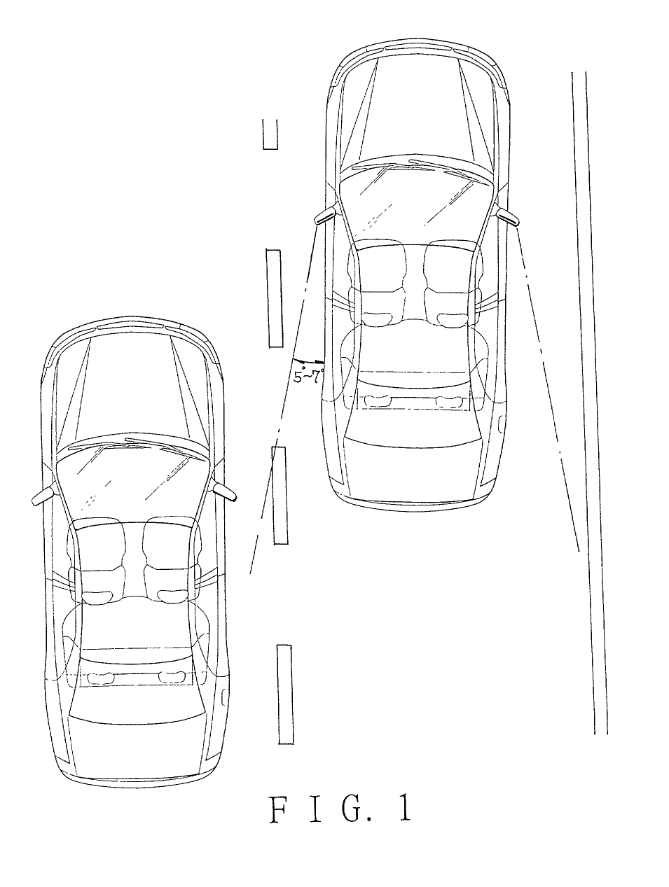

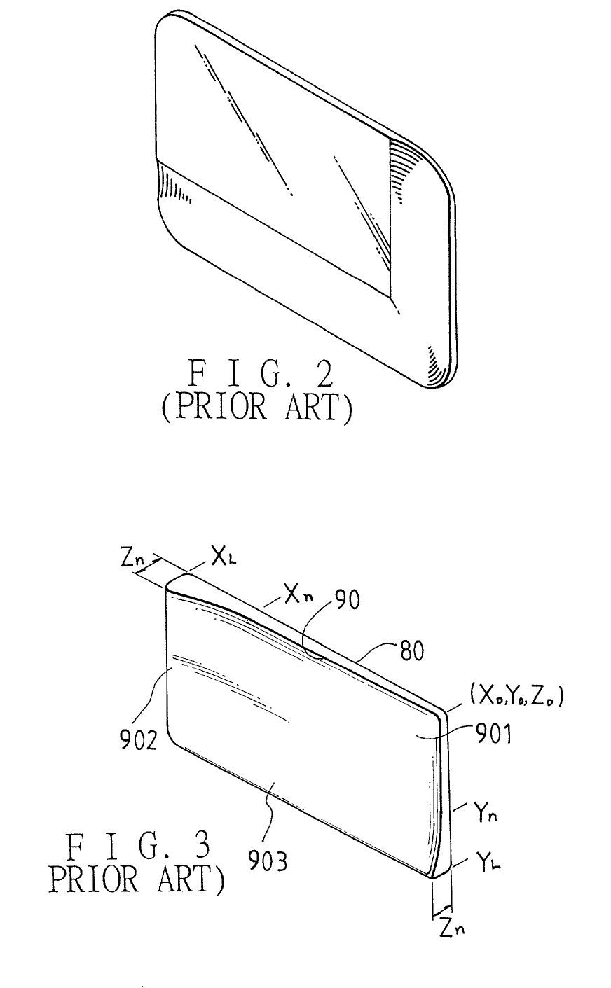

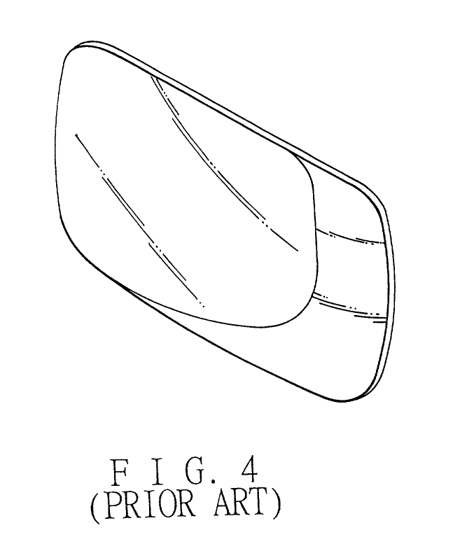

### DETAILED DESCRIPTION OF THE PREFERRED EMBODIMENT

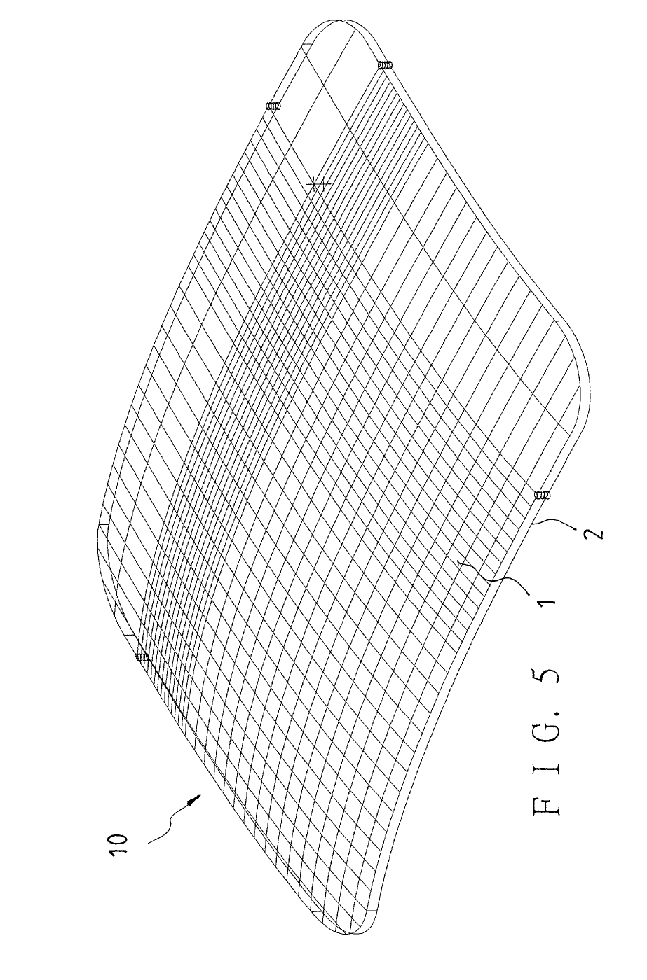

Referring to FIGS. 5, 6 and 7, a side mirror 10 (we use a left mirror as the example) of the present invention is made to have various curvatures from the right edge to the left edge, and from the top edge to the bottom edge respectively on the front surface 1.

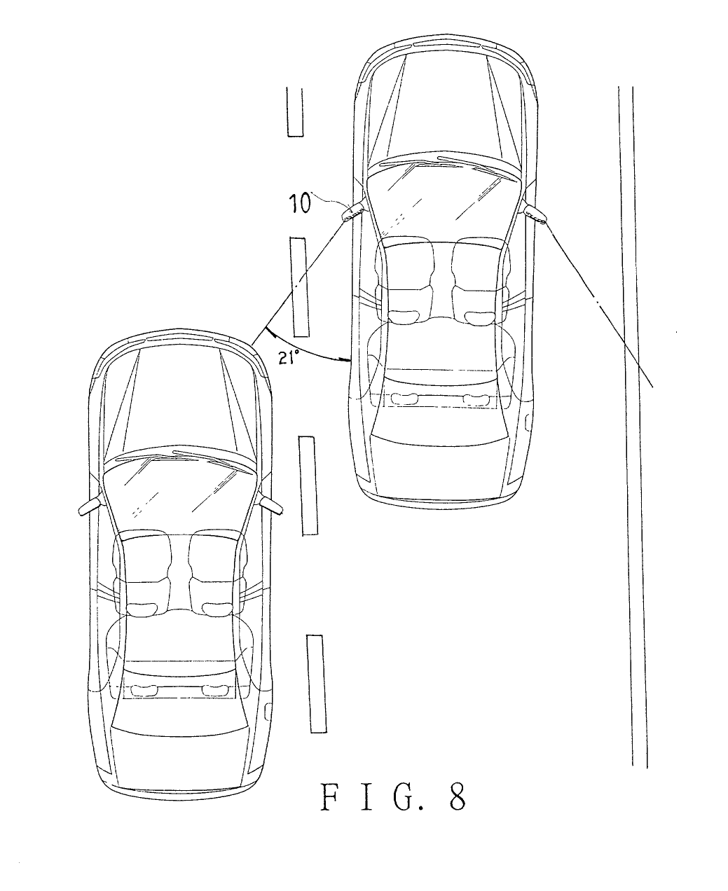

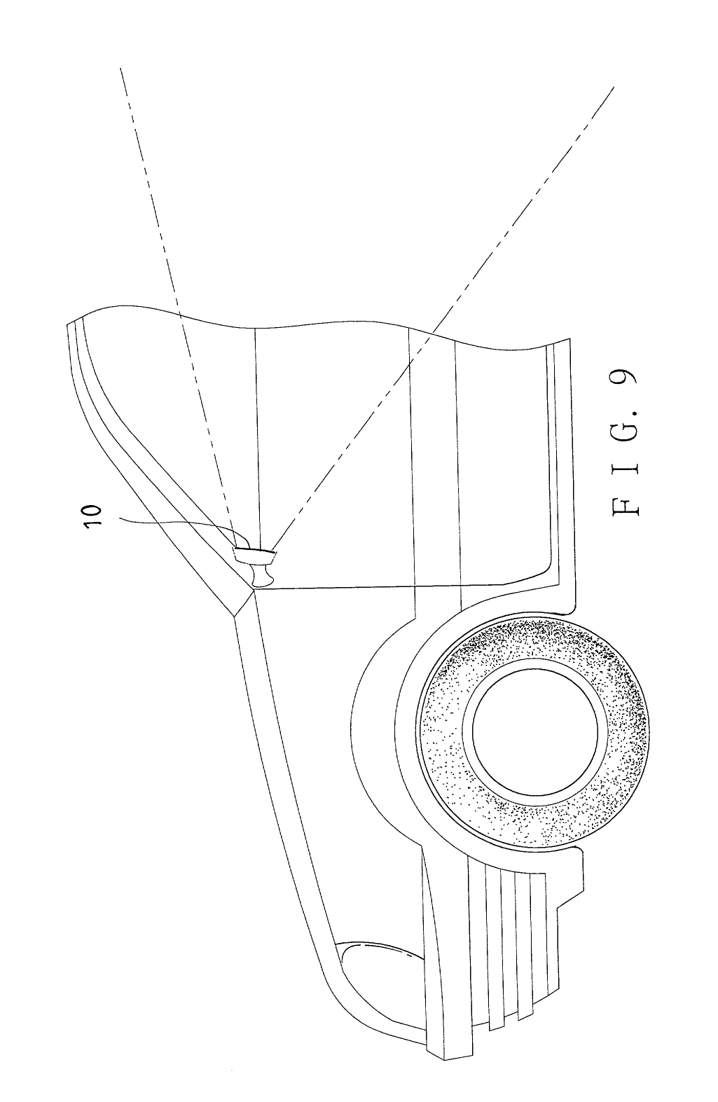

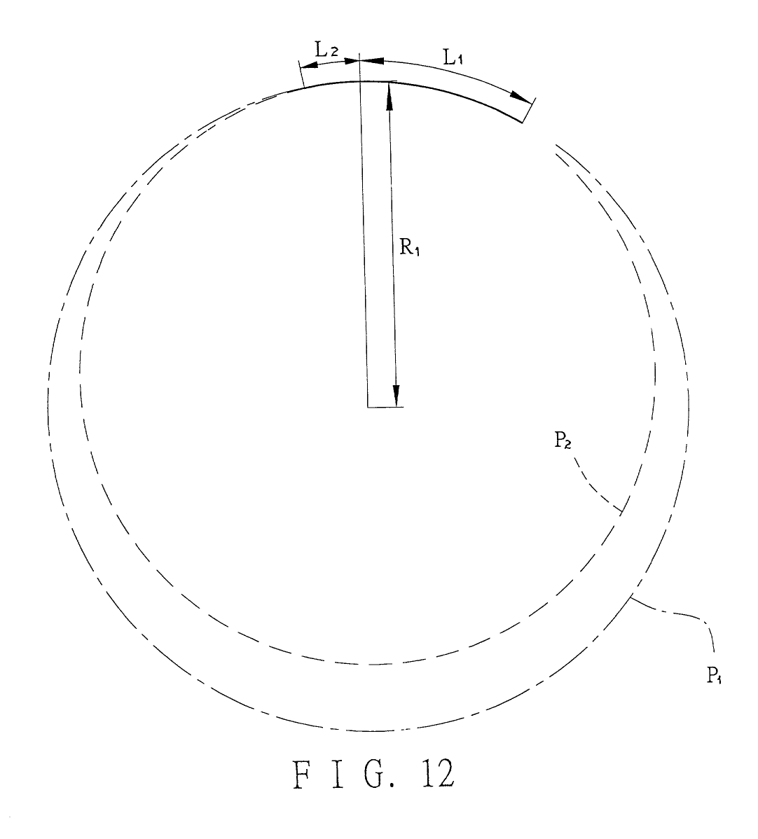

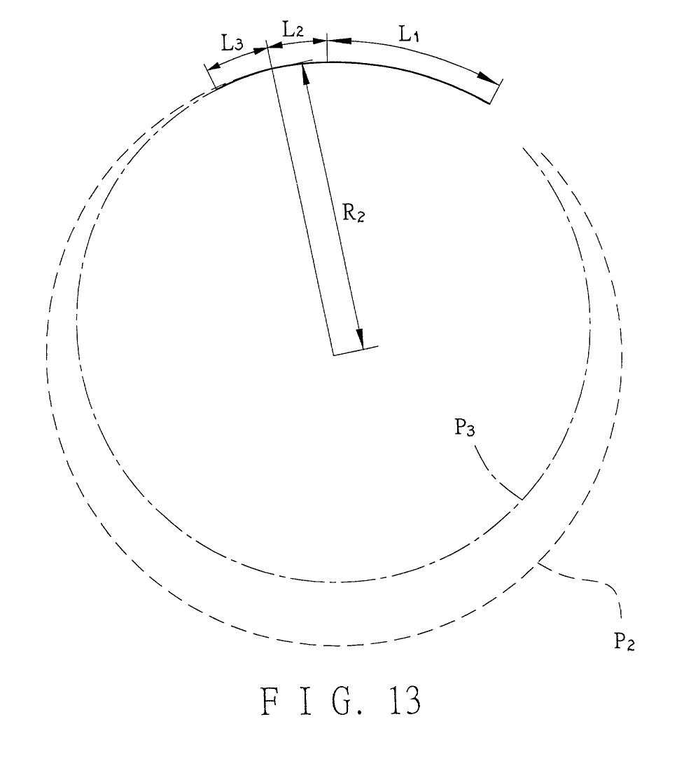

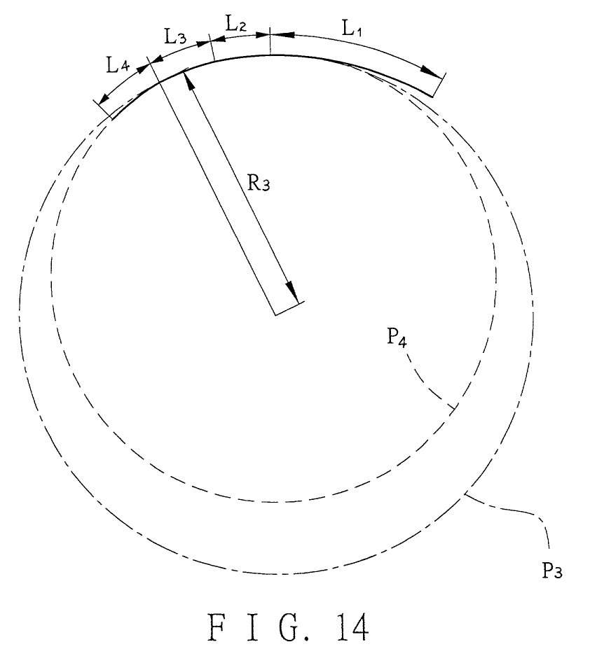

The curvatures from the right edge connected to the car to the left edge are defined by arcs of the twenty six circles becoming smaller and smaller in the radius, of which the largest one is 1800 mm and the smallest one is 50 mm. In other words, the curvatures are smaller at the right portion of the front surface 1 than at the left portion. The way of connecting arcs of circles of different diameters together is detailed herein: firstly, taking an arc L₁ (FIG. 12) from the largest circle P₁, of which the radius is 1800 mm in the present embodiment; secondly, drawing a second largest circle P₂ of 1700 mm in radius in such a manner that the tangent line of the largest circle at one end of the arc L₁ of the largest circle p₁ is also the tangent line of the second largest circles P₂; in other words, the center of the second largest circle P₂ is on the intermediate part of the radius connecting the end of the arc L₁ of the largest circle P₁ to the center of the largest circle P₁; and, taking an arc L₂ (FIG. 12) from the second largest circle P₂that is connected to the arc L₁; third, drawing a third largest circle P₃ of 1600 mm in radius such that the tangent line of the second largest circle P₂ at one end of the arc L₂ is also the tangent line of the third largest circle P₃; in the words, the center of the third largest circle P₃ is on the intermediate part of the radius connecting the end of the arc L₂ to the center of the second largest circle P₂; and taking an arc L₃ (FIG. 13) that is connected to the arc L₂ from the third largest circle P₃. In the same manner, an arc of a fourth largest circle P₄ (FIG. 14) is formed to be connected to the arc L₃, and so on. Thus, the front surface 1 of the side mirror has different curvatures, which become bigger and bigger from the right edge to the left edge. Therefore, the portion of the side mirror close to the left edge is curved in such a manner as to enlarge the range of visibility, as shown in FIG. 8. In addition, as can be seen in FIGS. 12, 13 and 14 in the present embodiment, arc L₁ is longer than arc L₂, and arc L₂ is longer than arc L₃ and so on.

The curvatures from the edge to the bottom edge are also defined by arcs of twenty six circles, which become smaller and smaller in the radius, in which the largest one is 1800 mm, and the smallest one is 50 mm; the curvatures are bigger at the lower portion of the front surface 1 than at the upper portion. The way of connecting arcs of circles of different sizes together are the same as the above, therefore it is not detailed again here; the arcs, which are taken from the circles from the top to the bottom edge are shorter for defining the front surface from the top to the bottom edge than for defining the from surface from the right edge to the left edge because the side mirror is longer from the right edge to the left edge than from the top to the bottom.

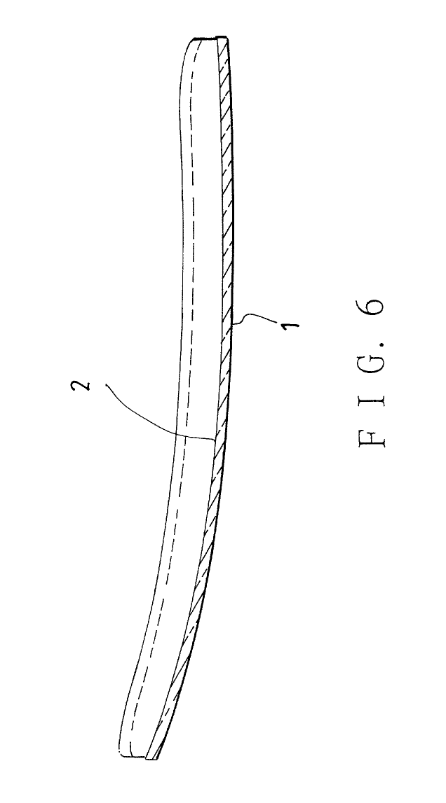

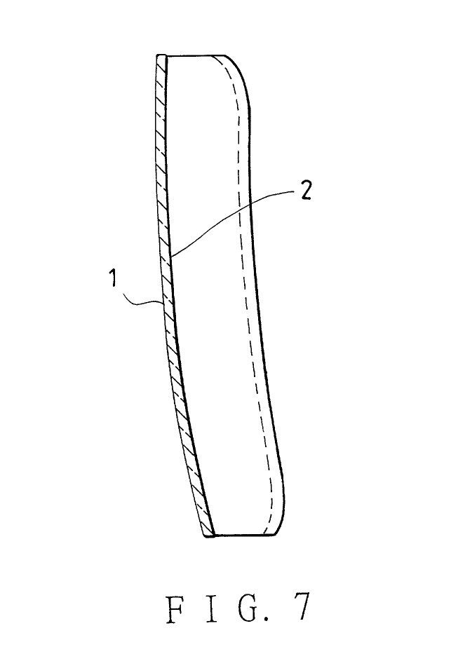

Because the curvatures of various portions of the side mirror are different, the side mirror is not the same as the surface of a sphere. And, the rear side 2 of the side mirror is shaped according to the corresponding pairs on the front surface 1 such that the side mirror is formed with a single thickness at all portions thereof, as shown in FIGS. 6 and 7.

Referring to FIG. 8, a first angle of visibility which is measured between the lateral imaginary defining line and the normal to the face of the driver, is about 21 degrees, much larger than that of the first conventional embodiment. Therefore, when the driver drives along, the range of visibility is greatly enlarged in respect of the cars that move along a short distance behind at two sides. In other words, the possibility of the driver failing to see other cars moving along a short distance behind at two sides with the present side mirror is greatly reduces.

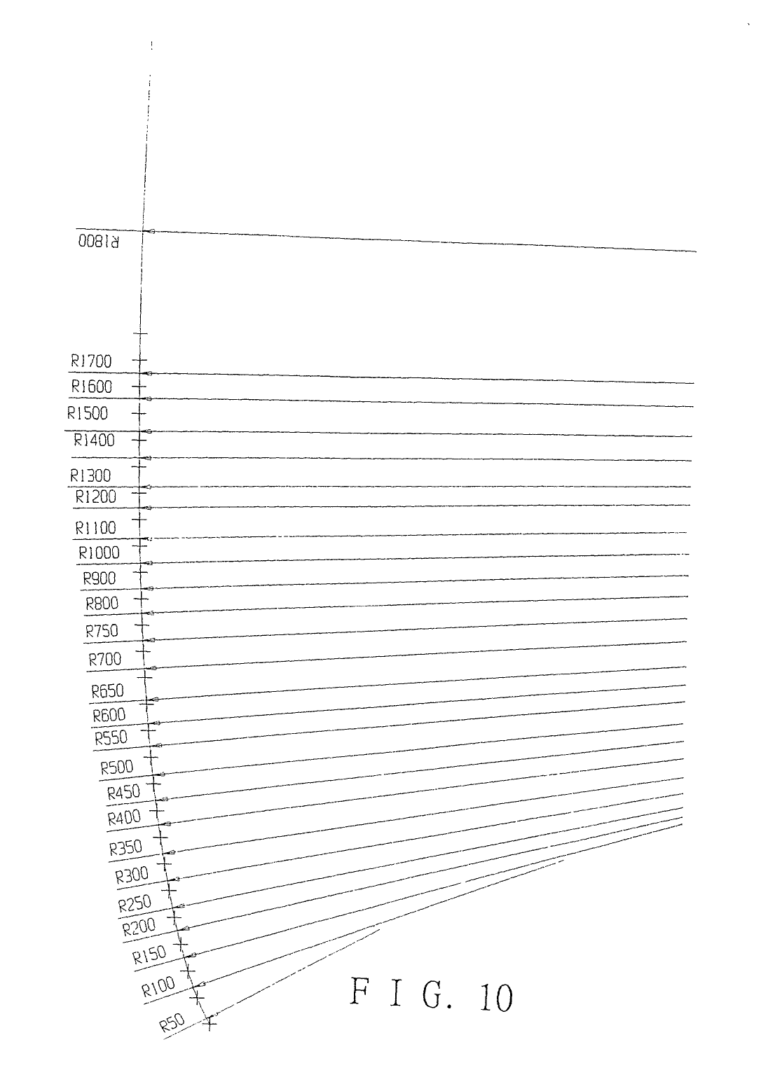

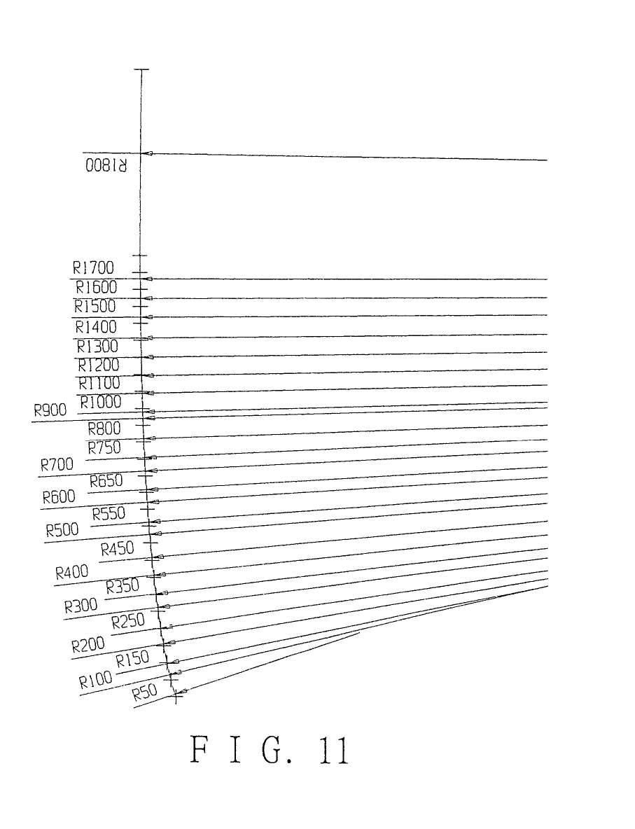

Furthermore, referring to FIG. 9, a second angle of visibility, which is measured between the upward and the downward imaginary defining lines, is also greatly enlarged as compared with a side mirror with a flat surface or the first conventional side mirror. Therefore, the range of visibility is greatly such that the driver can see the objects, animals or children on the ground at two sides of the car when he backs the car.

It can be easily seen that the surface of the side mirror of the present invention curves gradually, therefore it will not distort the images of objects.

What is claimed is:

1. A side mirror, comprising
a front surface, said front surface having an inner edge connected to a car and an other edge, said front surface being defined by arcs of a plurality of circles becoming smaller and smaller in sizes in such a manner that said outer edge thereof has a greater curvature than said inner edge; every adjacent two of said arcs being arranged in such a manner as to have a common tangent line on a joint thereof;
said front surface having a top edge and a lower edge; said front surface being defined by arcs of a plurality of circles becoming smaller and smaller in sizes in such manner that said lower edge has a greater curvature than said top edge; said arcs being arranged in such a manner as to allow every adjacent two thereof to have a common tangent line on a joint;
a rear surface, said rear surface being shaped according to said front surface so as to allow said mirror to have a single thickness.

2. The side mirror as claimed in claim 1, wherein said circles for defining said front surface from said inner edge to said outer edge are twenty six in number.

3. The side mirror as claimed in claim 1, wherein said circles for defining said front surface from said top edge to said lower edge are twenty six in number.
